(19) United States
(12) Patent Application Publication
(10) Pub. No.: US 2006/0123014 A1
(43) Pub. Date: Jun. 8, 2006

(54) Ranking Internet Search Results Based on Number of Mobile Device Visits to Physical Locations Related to the Search Results

(75) Inventor: David Way Ng, Redwood City, CA (US)

Correspondence Address: STUART T AUVINEN, 429 26TH AVENUE, SANTA CRUZ, CA, 95062-5319, US

(73) Assignee: David Way Ng, Redwood City, CA (US)

(21) Appl. No.: 10/904,958

(22) Filed: Dec. 7, 2004

(51) Int. Cl. G06F 7/00

(52) U.S. Cl. 707/100

(57) ABSTRACT

An Internet search engine ranks search results based on popularity with mobile-device users. Geo-position data from cell phones and other mobile devices are collected into a device geo-position database. The geo-position data is compared to locations of businesses in a business database. When a mobile device's geo-position moves inside a business location, a traffic counter for that business location in the business database is updated. When an Internet user performs a local search, the result set is sorted based on a rank that is at least partially determined by the traffic counters. The popularity-ranked search results indicate which businesses received the most mobile-device visits, an indication of the business's overall popularity. The popularity ranking may be adjusted for business size by dividing the traffic counter by the square footage of the business and sorting the result set based on the mobile-device visits, or repeat visits, per square foot.

### FIELD OF THE INVENTION

This invention relates to Internet search engines, and more particularly to ranking of search results using geographical position data collected from mobile devices.

### BACKGROUND OF THE INVENTION

The explosive growth of the Internet has resulted in huge numbers of new web pages being published. Finding specific information on the world-wide web of billions of pages of information could be difficult and even limit further growth of the Internet. However, search engines such as those by Google and Yahoo allow for rapid location of desired information despite the information glut.

Search engines use web crawlers to locate new or modified web pages. Textual content on these pages is analyzed and keywords extracted from the pages. A search index is updated, such as by adding the web-page address to a list of web pages that contain a word. A weight or rank for the web page can also be generated and stored in the index, such as by the number of times that word occurs on the web page.

When a user types in a search word or term, the search engine can generate a result set of web pages that contain the search term. Web pages within this result set may then be ranked, and the highest-ranked results displayed to the user.

A variety of other factors can go into the web-page rank. These ranking factors can include the number of times other search uses have clicked on the link to that web page, how extensively that web page is linked to from other web pages, or by personal reviews and ratings of web pages or sites. Some web sites may even pay the search engine for a more favorable ranking.

More recently, search results may be limited to those pertaining to a limited geographical area. For example, when a search user types in “Sushi 94086”, a local search may be performed for Sushi restaurants in the Sunnyvale, Calif. area, centered on a central position within the zip code 94086.

Sushi restaurants are listed in a ranked order determined by distance to the central position. Sushi restaurants outside the 94096 zip code are also included in the local search results. A map may be displayed next to the search results to show locations of the restaurants.

Rather than use an arbitrary position or zip code, the user may be prompted to enter in a current position, such as a street address, or perhaps the user's current position is extracted from the user's mobile device, such as a geo-location derived from a cell phone. Results may then be ranked by distance (in miles) from the user's actual current position. The closest Sushi restaurant may then be quickly found.

Unfortunately, the closest Sushi restaurant may not be the best restaurant, or even a good restaurant. Some local results may provide links to user reviews, but these reviews depend on users typing in their comments and may be biased. Relatively few users take the time to provide reviews. Links to more formal reviews may also be provided, such as from a restaurant critic, but again relatively few restaurants may have reviews, making ranking by reviews difficult.

What is desired is an automated system to determine user ratings. User ratings based on popularity of a business are desirable. An automated way to collect traffic statistics for business locations is desirable. Ranking of Internet search results using such traffic statistics is also desirable.

### BRIEF DESCRIPTION OF THE DRAWINGS

FIG. 1 shows cell-phone users visiting businesses in a neighborhood.

FIG. 2 is a diagram of collecting geo-position data from mobile devices into databases for popularity-ranked searches.

FIG. 3 highlights updating traffic counts using the geo-position and business databases.

FIG. 4 shows popularity-ranked local search results that are normalized for square-footage of the business.

FIG. 5 highlights visit detection.

FIG. 6 is a flowchart of entry detection and traffic-counter incrementing.

FIG. 7 shows a 2-D map of search results with star ratings determined by mobile-device visits.

### DETAILED DESCRIPTION

The present invention relates to an improvement in Internet search engines. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

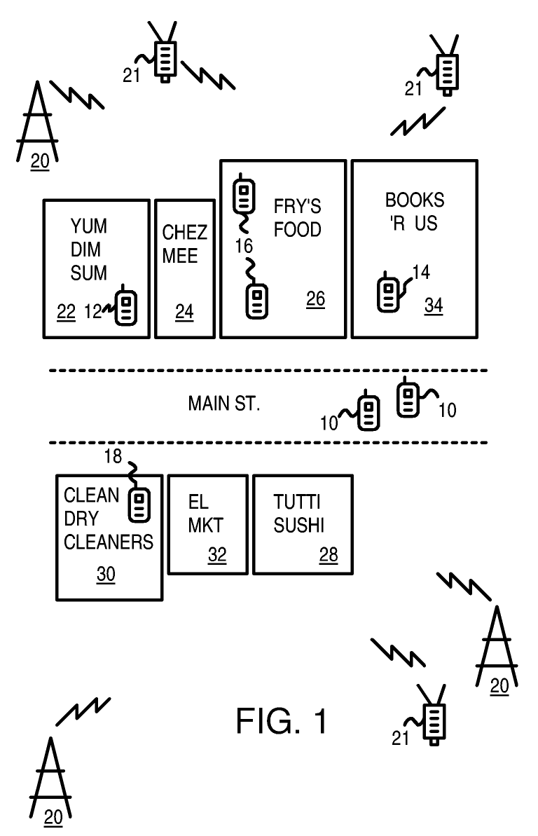

FIG. 1 shows cell-phone users visiting businesses in a neighborhood. Several businesses are on Main St., including Books-R-Us bookstore 34, Clean dry cleaners 30, an El Market 32. However, Main St. is known for its variety of restaurants, including Tutti Sushi 28, Yum Dim Sum 22, Chez Mee 24, and Fry's Food 26.

The geographic positions (geo-positions) of cell phones or mobile devices 10, 12, 14, 16, 18 are collected by triangulation techniques to cell towers 20, or by Global-Positioning-Satellite (GPS) data determined by GPS signals sent from several of GPS satellites 21. The ability to determine the geo-locations of cell phones is mandated by law in some countries to allow for quick location of cell-phone callers to emergency (E911) centers.

The cellular infrastructure often allows for geo-position data to be generated and collected for mobile devices 10, 12, 14, 16, 18. This geo-position data may be compared to location data for businesses to determine when one of mobile devices 10, 12, 14, 16, 18 is inside a local business. For example, when geo-position data collected from mobile device 12 is compared to the location for Yum Dim Sum 22, it is determined that mobile device 12 is inside Yum Dim Sum 22. Similarly, mobile devices 16 are found to be within Fry's Food 26, and mobile device 18 is found to be inside dry cleaners 30.

The geo-position data may be collected when a user makes a phone call, but the geo-position data may also be collected continuously. For example, the geo-position data for cell phones may be collected every minute or every 30 seconds when the cell phone is powered on, even when not making calls. The geo-position data may be immediately generated and sent to the cellular network, or may be collected by the mobile device over a longer period of time and later sent to the cellular network, such as when a call is made.

Popularity Ranking Based on Collected Geo-Position Data

The inventor has discovered that such geo-position data may be collected and compared to business locations to determine when customers with mobile devices visit businesses. This visit information may be collected for many users over time to generate traffic statistics for each business, such as the number of visits per month.

The number of visits per month for a restaurant or other business may be an indication of the popularity of that business. Popularity rankings of local businesses may be generated using the traffic statistics. Rather that rank strictly on distance to a user, businesses within a neighborhood may be ranked on popularity, or the number of visits per month.

Since this traffic information is collected automatically from cell phones and other mobile devices, popularity data is obtained without requiring customers to write reviews. The traffic data is less subjective than written reviews, since the number of customer visits is collected. Traffic data can be obtained without obtaining the explicit permission of the businesses.

Traffic Data Adjusted for Business Area (Sq-Ft)

The inventor has further realized that traffic data may be adjusted for the size of the business. For example, Fry's Food 26 is a larger restaurant than Chez Mee 24 and can seat many more customers at a time. Fry's Food 26 may receive many more visits than Chez Mee 24, even though Chez Mee 24 has much better food and is full during meal times. The traffic data may be adjusted by the area of each business to normalize for business size.

Users of mobile devices 10 may perform a search for local restaurants that is ranked by popularity. The popularity ranking may reveal that Tutti Sushi 28 receives relatively few visits while Fry's Food 26 receives many. Normalizing for business area, the popularity ranking may show that Yum Dim Sum 22 is the most popular restaurant on Main St. Thus users of mobile devices 10 may choose to eat at Yum Dim Sum 22 rather than other restaurants on Main St. based on the popularity rankings automatically collected from other users of mobile devices 12, 14, 16, 18.

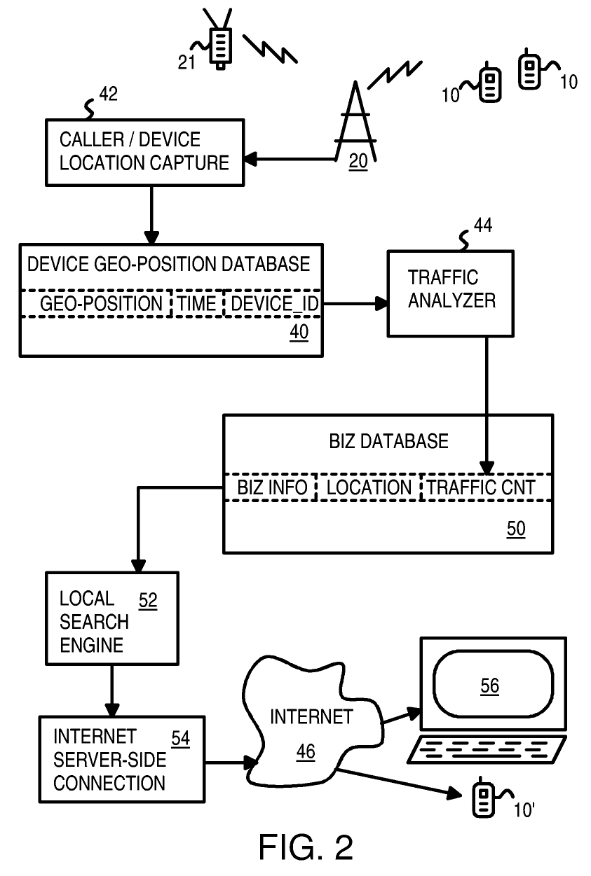

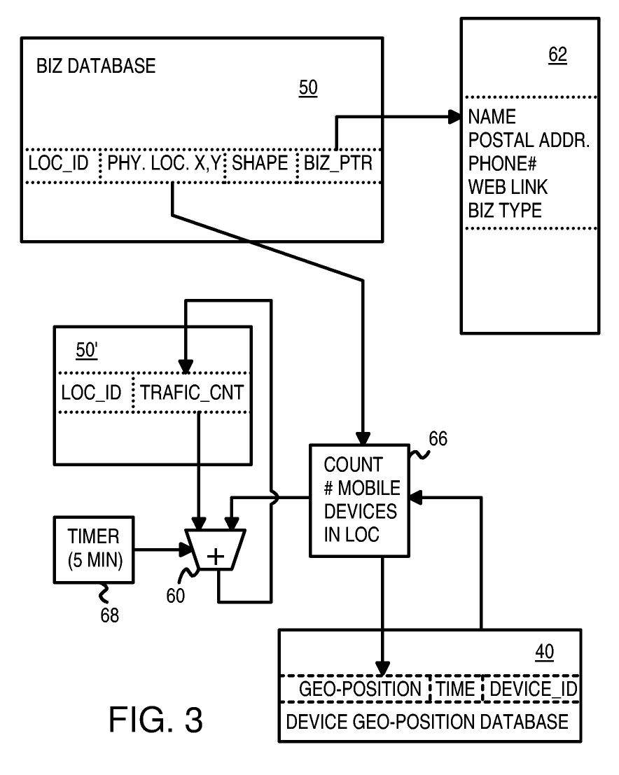

Geo-Position Updates Traffic Counters—FIGS. 2, 3

In a simple embodiment, the cellular infrastructure may periodically collect geo-position data from users and compare this geo-data to business locations to determine when users are visiting a business. Thus number of visits may then be accumulated over time for each business. Ranking can be based at least partially on the visit data, which may be adjusted for business size.

FIG. 2 is a diagram of collecting geo-position data from mobile devices into databases for popularity-ranked searches. Mobile devices 1 0 communicate with a cellular network over cell towers 20, which may triangulate to find geo-positions for mobile devices 10. Geo-position data also may be received from GPS satellites 21 by mobile devices 10 and reported back to the cellular network. The cellular network is able to capture and timestamp this geo-position data using location capture equipment 42. The geo-position data is loaded into device geo-position database 40. Entries in device geo-position database 40 can include geo-position, time, and a device identifier that identifies a particular mobile device 10. Entries could be grouped or indexed by geo-position, time, or device and could be arranged in device geo-position database 40 in a variety of ways.

Traffic analyzer 44 examines entries in device geo-position database 40 to find traffic patterns. Traffic analyzer 44 can also read business locations from business database 50 and compare the business locations to geo-positions from device geo-position database 40 to determine when an entry in device geo-position database 40 is physically within a business in business database 50. When a geo-position falls within a business location, a traffic counter or traffic score may be updated for that business. For some algorithms, such as recursive algorithms, the traffic scores of other businesses may also need to be updated if their traffic scores depend on the traffic score of other businesses.

Each business entry in business database 50 can have a traffic counter that is incremented for each mobile device 10 found to be within the location defined for that business. The location could be represented by a range or list of Cartesian coordinates, polar coordinates, or some other format. A location can have one or more predefined shapes and can be approximated by various models, such as circles, rectangles, or polygons for 2D shapes and spheres, boxes, or polyhedrons for 3D shapes. The coordinates can be offset from a reference point such as the center of the location and can use different measurement units such as meters instead of degrees of latitude, longitude, and altitude. Business information stored in that entry, or linked to that entry, can include the business name, address, phone number, links to user ratings, web-site address, etc.

When a user performs a local search, such as a user of personal computer PC 56 or another mobile device 10′, the user makes a connection to server 54 through Internet 46 or some other network. Server 54 extracts the search terms from a request from PC 56 or mobile device 10′, and sends a search query to search engine 52. The location of PC 56 or mobile device 10′, or a desired location to center the search on, is inputted to server 54 or received by it.

Using the search terms and the search center location, search engine 52 consults business database 50, directly or through another intermediate database such as a list of search terms and search results. Businesses matching the search terms that are close to the search center are included in the result set.

Businesses within the result set are then ranked by local search engine 52. Ranking is performed by examining the traffic counters for each business in the search set. Businesses from business database 50 in the result set that have the highest traffic counts (traffic counter stored in business database 50) can be listed first.

Ranking may be a combination of physical distance of the business from the search center and the traffic counts stored in business database 50. For example, a 50-50 weighting of traffic counts and distance to search center could be used for ranking, or only the closest 5 or 10 businesses in the result set could be displayed, but displayed in an order based on the traffic counters.

FIG. 3 highlights updating traffic counts using the geo-position and business databases. Business database 50 contains business entries that include a business or location ID, a physical location of the business, a shape of the business, and a pointer to more information on the business. The pointer can link to more detailed records describing the business in linked records 62, such as business name, postal address, phone number, web site, type of business, etc. Links to more information, such as written user reviews or news articles about the business could be included as pointers in linked records 62 or business database 50.

The shape of the business contains some kind of information describing the physical area or boundary of the business. The shape might by x and y dimensions of a rectangular store, or a radius from a center of the business that is stored as the physical location x,y field in business database 50. The physical location x,y point could be defined as the south-western-most point in the business, or a center point, or another reference point.

Geo-positions of mobile devices from device geo-position database 40 are compared to the physical x,y locations of business entries in business database 50 and their shapes to determine when the geo-position is within the business. Business locations in business database 50 could be indexed to make subsets of businesses in a small area, zip code, city block, neighborhood, or range of coordinates for more rapid comparisons. Alternately, business entries in business database 50 could be arranged by x coordinate, and all entries having a matching x coordinate could be checked.

When it is determined that the geo-position from an entry in device geo-position database 40 falls within a business location and shape from business database 50, then device counter 66 activates adder 60 to increment the traffic count for that location ID. The location ID in traffic a counter portion 50′ of business database 50 corresponds to location ID's that index entries in business database 50.

Rather than increment traffic counts as each geo-position entry is processed, device counter 66 could process several geo-position entries from device geo-position database 40 for a business location before activating adder 60. Temporary storage of traffic updates could be used before updating the traffic counts in business database 50′.

Timer 68 could be used by device counter 66 to update traffic counts only once per time period for any given mobile device. For example, when a mobile device is within a business for 20 minutes, timer 68 could ensure that the traffic count is updated only every 5 minutes. Device counter 66 could keep a list of device ID's inside that business, and update the traffic counter by the number of unique devices inside the business every 5 minutes. When a mobile device sends its geo-position multiple times within the 5 minutes, device counter 66 ignores the geo-position data when the device ID is already listed as being inside the business. Thus over-counting is minimized.

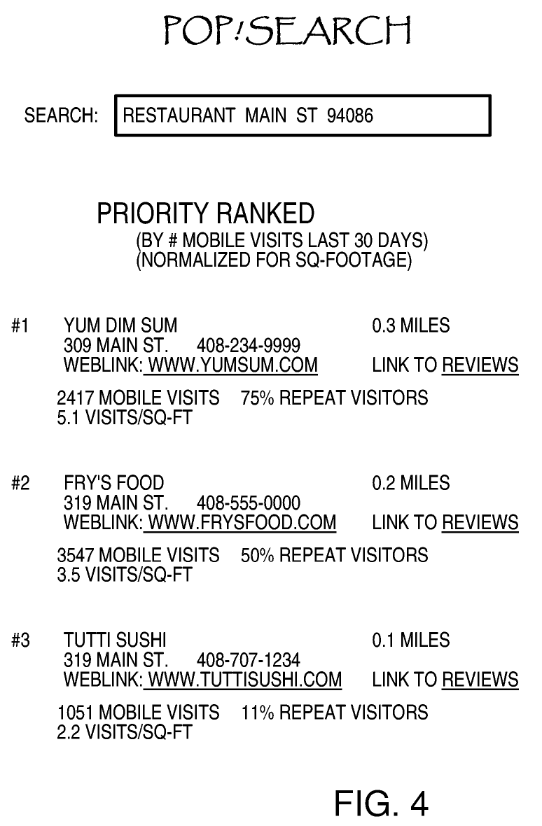

FIG. 4 shows popularity-ranked local search results that are normalized for square-footage of the business. The user enters the search term “restaurant main st 94086” to look for restaurants on Main Street in the 94086 zip code area. The local search engine could include results that are outside the 94086 zip code but are nearby.

The top 3 results are shown to the user. They are ranked by popularity, based on the number of visits in the last month. However, the results are adjusted for the size of the restaurant, such as by dividing the number of visits by the square footage of the business.

The top-ranked result, Yum Dim Sum (22 of FIG. 1), has its address, web-site link, and phone number displayed, along with the distance (in miles) to the search center. Although Fry's Food has more visits in the last month than did Yum Dim Sum (3547 vs. 2417), Fry's Food is larger and can hold more customers than Yum Dim Sum. Thus the normalized visit counts per square-foot (3.5 for Fry's Food, 5.1 for Yum Dim Sum) favor Yum Dim Sum as the top-ranked result.

The third-ranked result, Tutti Sushi, had fewer visits (1051) and a lower normalized traffic score (2.2 visits/ft-sq) than the two top-ranked results. The user can also see that the percentage of repeat visitors (11%) was very low for Tutti Sushi compared with the higher-ranked restaurants.

Repeat visitors can be detected by storing a list of mobile device ID's that have visited a restaurant in the past. When a new mobile device is detected within the business area, its mobile device ID is compared to this list of past visitors. When a match is found, the mobile device is a repeat visitor. A separate repeat visit counter can be incremented for that business. The percentage of repeat visitors can be calculated by dividing the repeat counter by the traffic counter for a business.

A variety of information may be displayed with each search result. The business name, address, web-site link, and phone number displayed, along with the distance (in miles) to the search center. An icon or logo for the business could also be displayed. Links to written user reviews for this business, or an overall user rating (not shown) may also be displayed. Other information, such as the raw traffic counter value, the normalized traffic count, and the percentage of repeat visits may also be displayed, or may be hidden. Buttons to display the next-lower-ranked results, and a variety of other web-page information may be displayed but is not shown for simplicity.

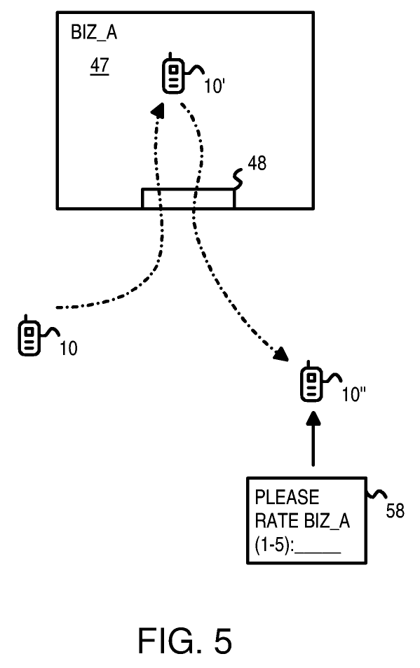

Visit Detection—FIG. 5

While the simplified embodiment described above simply detects when a mobile device is within the boundaries of a business, over-counting may occur. For example, customers who visit for a long period of time may increase the traffic counter more than quick visitors. Restaurants with slow service could have higher traffic counts, and better rankings, than more efficient restaurants.

Visit detection can help to overcome these problems. The traffic counter is incremented just once for each visit, regardless of the length of the visit. FIG. 5 highlights visit detection. Business 47 has an entry in business database 50 of FIGS. 2-3 and has a traffic counter. The entry of a mobile device into a business is detected and causes the traffic counter to be incremented.

Initially, mobile device 10 is outside of the area for business 47. When the mobile user walks through door 48 into business 47, its geo-position now matches the location of business 47. The previous position of the mobile device is found, such as by searching device geo-position database 40 for a prior entry for the mobile device ID, or by a present-location field for the mobile device, or

When the previous position was outside business 47, and the current position is inside business 47, then the mobile device user has just entered business 47. The traffic counter for business 47 is incremented.

Mobile device 10′ may remain inside business 47 for any length of time, and may even switch the phone off and on. However, the traffic counter is incremented just once for this mobile device, since entry was detected just once. The mobile device ID may be added to a list of mobile devices inside business 47.

When the mobile user leaves the area of business 47, indicated as mobile device 10″, the exit may be detected in a similar manner. Alternatively, when a device ID from the list of devices inside the business is no longer present inside the business, and reports a geo-position outside of business 47, then an exit is detected. Rating message 58 may be sent to mobile device 10″ as a text message. Short-Message Service (SMS) may be used for rating message 58.

Rating message 58 asks the user to rate the business, such as on a scale of 1 to 5. These user ratings may be accumulated for each business, allowing for ranking based on these exit ratings. Rating messages can be sent to the user after the user enters the business or after the user leaves the business. The traffic score may also depend on user ratings. The increment value for each visit may be weighed by the user's rating. Good reviews could be given larger increment values. Bad reviews could be given lower or negative increment values.

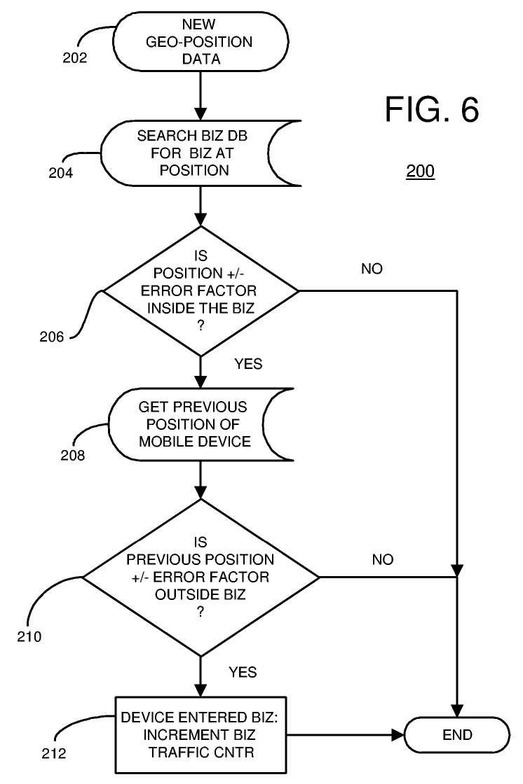

FIG. 6 is a flowchart of entry detection and traffic-counter incrementing. Traffic-analyzing routine 200 reads geo-position entries from device geo-position database 40, which may be in approximate time order or in some other order, such as in received order but grouped by device ID. As an entry is read, the new geo-position is extracted from the entry, step 202. The x,y coordinates for this geo-position are compared to x,y locations of businesses in business database 50, step 204.

An error factor may be added and subtracted from the geo-position to account for limited accuracy of geo-position data. When the geo-position plus or minus the measurement error is considered to be inside a business location, step 206, then the previous position of the mobile device is read, step 208, such as from an earlier entry in device geo-position database 40.

When the previous geo-position plus or minus the error factor is also within the business, then the entry of the mobile device into the business has already been detected and accounted for. No further action is taken, and routine 200 ends or moves on to the next geo-position data, step 202.

When the previous geo-position plus or minus the error factor is considered to not be inside the business, then entry of the mobile device into the business is detected. The mobile device moved from outside the business to inside the business. The traffic counter for that business is incremented to account for the visit. Rather than detect entry into a business, exiting a business could be detected. Crossing a business boundary could be detected, either for entry or for exit. Some businesses could detect entry and others could detect exit.

The previous position may also be determined by keeping a list of mobile device ID's that are currently inside the business, and checking for the device ID in the list. If the device ID is in the list, then the device had already entered the business and the routine ends. If the device ID is not on the list, then the mobile device has just entered the business and the traffic counter is incremented for this mobile device in step 212.

Detecting entry of a mobile device into a business may be considered more accurate since each device is counted just once per visit, regardless of the length of visit. The error factor can reflect precision of the geo-position data. For example, geo-position data may be accurate to within 1 meter, and the error factor can be 1 meter or a portion of the meter, such as half a meter. When using a different method for obtaining the geo-position data, such as triangulation, the precision may drop to 5 meters, and the error factor can be adjusted, such as to 5 meters or to 2.5 meters or to some other value. Thus as the mobile device enters calling areas that use a different technology to obtain the geo-position data, the error factor can be adjusted accordingly. Even when using the same technology, the precision may drop in some areas or at some times, such as when fewer GPS satellites are available, or when cell towers are farther away or fewer cell towers can be used to triangulate the geo-position.

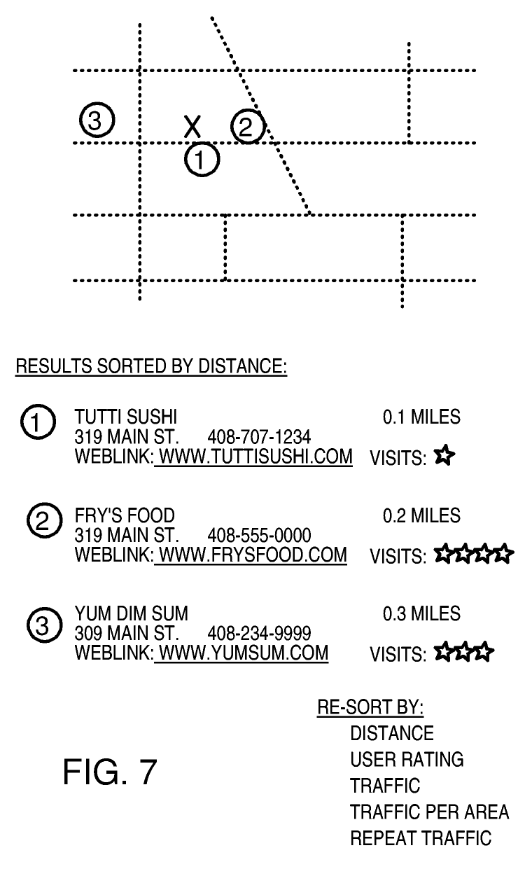

FIG. 7 shows a 2-D map of search results with star ratings determined by device-device visits. A street map is show at the top of the page, with an X marking the search center, which could be a location of a mobile device user, or a fixed location such as a street corner or center of a zip code or town. Map detail such as street names and landmarks may also be displayed, but is not shown in this level of detail.

The search term could be the same as for FIG. 4, with the top 3 results having their locations displayed graphically on the map. In this example the ranking is done by distance from the center, without regard to visit popularity rating. However, the visit popularity rating of each result is shown as a number of stars next to the business name. For example, Tutti Sushi is the #1 result by distance, but it receives only one star since it had few visits. The #2 result, Fry's Food, receives 4 stars since it received many visits. The #3 result, Yum Dim Sum, receives three stars.

Thus the search user can quickly see that although Tutti Sushi is closer, the #2 and #3 results have better traffic ratings. The name, address, phone number, and web link for each result are also displayed. When the results are sent to a mobile device, these and other details may be hidden to account for the smaller mobile-device screen.

The user may re-rank the search results using other factors. A list of ways to re-sort the search results is shown on the bottom of the page. The distance selection is currently highlighted since the results are currently sorted by distance. The user can click on user rating to sort by written user ratings, if any. However, since only a few written user ratings may be available for each business, clicking on traffic allows the user to sort by the number of visits in the last month. Traffic sorting benefits from a larger data set, since visit data is automatically collected from mobile devices without requiring the user to write a review.

Since the traffic sorting may be skewed to larger businesses that can handle more patrons, clicking on traffic per area adjusts the visit data for business size. For example, the number of visits may be divided by the square-footage of the business, or by a factor related to the approximate business size. These factors can be estimates and adjusted in a variety of ways. Restaurants that are only open for dinner may have an additional adjustment factor since they are closed for lunch. Separate traffic counters could be kept for different times of the day or week, such as for lunch and dinner, or weekends.

When a repeat traffic counter is also available for each business, the user can sort by repeat traffic. This may be an even better indication of the quality of the business, since unhappy customers are unlikely to re-visit the business. For the result and traffic data of FIG. 4, Yum Dim Sum would be the #1 ranked by percentage of repeat visits.

Sorting could also be performed by a combination of factors. For example, the ranking parameter could be a combination of one-third visits per area, one-third repeat visitors, and one-third distance. Various other combinations could be tested and offered.

### ALTERNATE EMBODIMENTS

Several other embodiments are contemplated by the inventors. For example a variety of tracking technologies may be used, such as Global-Positioning-Satellite (GPS), triangulation to transmitter towers or other locator devices, signal time differentials, etc. Special tracking devices such as wireless monitors at an entrance to a business could be installed to detect mobile-device visits, and this data could be reported for popularity rankings. While geo-position event data could be loaded into device geo-position database 40 or analyzed in real-time, it may also be delayed. The mobile device may accumulate and store geo-position event data, such as every 5 minutes, and then send it at a later time, such as once an hour or once a day. Geo-position data may be obtained on demand. If a central server sees a user near a location of interest, it may order the mobile device to take more readings and/or increase its integration time to improve accuracy. Also, it can take additional readings if user moves by more than 100 m. Tracking preferences can be individually configured and changed. Search terms can be one or more words AND'ed together, or more complex search terms can be used, such as grouping, proximity, exclusion, etc.

Many partitionings of databases, entries, and records are possible. Entries may be split among several tables and linked together. Relational databases, partitioned data tables, linked lists, and other database structures may be used, rather than a single table database. Fields can be added for a variety of purposes, including pointers or links to additional data. Many variations and improvements can be made to the popularity-search web site and the software routines and forms displayed. Displayed web pages may be adjusted and simplified for display on mobile device screens. A variety of information on each business may be displayed, such as price data, links to menus or services, reviews, related businesses or branches, etc. A database can also be implemented as a file. For example, the geo-position database can be implemented as a text file of mobile device position entries with comma separated fields. Adder 60 may be more complex than an adder, and include control and multiplexer (mux) logic, for example. Other blocks could likewise include more complex functions.

Many different user interfaces, online forms, and partitioning of software modules can be used. Some of the server functions can be performed on the client device or across multiple processors, servers, or machines, even in geographically diverse locations. While local search results have been described, regional, national, or world results could be ranked using mobile-visit data. Multiple disjoint regions may be ranked.

Mobile devices could be cellular phones, personal digital assistants (PDAs) with wireless capability, features phones, combination wireless devices, wearable computers, clothing with embedded wireless devices, etc. While the local search has been described on the public Internet, it could be provided as a paid service on the Internet, or as a private service on a single cellular network that is available to mobile device users of that cellular network.

While for-profit businesses have been described, the businesses could be non-profit businesses or other organizations. Business locations could include other kinds of locations that could be popularity-ranked with similar techniques, such as parks, theaters, churches, beaches, ski runs, hiking trails, etc. While a time period of one month has been described, the number of visits per week, per year, or average visits per lunch period could be used for ranking and sorting. Businesses could be restaurants, stores, banks, doctors, dentists, professional services, beauticians, etc. Rather than have fixed boundaries and shapes, business locations could have a center point and a radius, and may even overlap adjacent businesses. Mobile devices in an overlap region between two businesses could have their visit split among the adjacent businesses, or be credited to the business that the device spends the most time in.

Profiles of mobile device users could also be created. A mobile user who lives in the local area could be given more weight than an occasional visitor to the area, since the local person may know the area better. An intermediate database could be used to store ranking values rather than traffic counters. All the traffic counters could be examined and reset periodically and the ranking values updated. The search engine could then use the ranking values rather than the traffic counters when performing ranking within a result set. Fairly complex algorithms can be used for ranking that have the popularity rank or traffic counter as just one of many variables.

Rather than have a 2-dimensional (x,y) geo-positions and business locations, 3 dimensions (x,y,z) may be used. Radial dimensions or polar coordinates, or other kinds of coordinate systems could be substituted. A high-rise building or subway may share x,y coordinates with other locations, and thus can benefit from a third dimensional coordinate to distinguish geo-positions and locations on different floors or levels of the same building. Dimensions may be in feet and area in square feet, or in meters and sq-meters, or in other units. Values may be normalized to a base value of 1.0 or to some other base value, such as per 1,000 square feet. Repeat visits per square foot, or per 1,000 square foot could be used for the primary ranking, or percentage of repeat visitors, or some combination. Mobile device ID's could be added to a repeat visitor list for a business only when the visit was on a prior day, or the repeat visitor lists could be updated once a day, such as a night, so that repeat visits on the same day are not counted.

Improved geo-position information could be requested and on demand. When a mobile device is found to be near a location of interest, or on the borderline of multiple locations, the mobile device could be ordered to take better readings of its position. One way is to take readings more frequently, or to use a longer integration time, or to switch to higher-accuracy service mode.

Geo-position accuracy can vary with GPS receiver and antenna, location (geographic latitude), and surrounding objects (possibly blocking reception or causing multi-path reception), satellite constellation status, and ionosphere conditions.

A geo-position may be a point. Including the measurement error results in an elliptical two-dimensional circle or a three-dimensional sphere. If the circle is not completely within the physical boundaries of a location, then it is not certain if the device is inside the location. Alternatively, if more than a certain portion (such as 50%) of the circle is within the boundaries, then it could be considered inside the location. Other information may be supplemented to pinpoint the location. For example, the user could confirm that he is at the location in question.

Incrementing of the traffic counters could be performed by adding and/or subtracting a number. The number could be a floating number. For example, a visit could be worth +5 rather than +1 to the counter. A negative number could also be added, reducing the traffic counter, such as when a visit actually lowers a traffic score, or when more negative values are considered to be higher in rank. Traffic counters can also be updated with a new value, or re-initialized. Various other mathematical updates could be made. Traffic counters or traffic scores may be updated using complex algorithms or could just be incremented. The error factor may be a number that is multiplied by the geo-position or location, or added or subtracted or otherwise mathematically combined. The result set could be a list of entry IDs, or a list of partial or full entry records, or have some other format.

A location entry could be a group of disjoint locations. Geo-position and location databases can be implemented as separate or combined databases. The system can be implemented as a distributed system. Visits to a different branch of the same store can be counted separately or as one business. Optionally, a visit is only counted as a real visit if the visitor has been in the store for at least a certain amount of time. Visits tracked by other means (credit card transactions, on-premises equipment, proximity sensors at the door, etc) can also be taken into account. For example, a credit card transaction at a business location, or an online business, could be counted as a visit to that business and the traffic score of that business could be updated accordingly. The transaction amount could also be used as a weighting factor for each visit. Traffic statistics may or may not be visible in the search results page. Search results could be presented as an ordered list, on a map, or audibly. Search results could by default be ranked by distance and the user given options to sort by various traffic statistics.

Privacy for mobile users is important, so a way to protect user privacy could be provided. For example, the mobile device ID may be an alias of the actual device ID to make it difficult to trace back to an actual mobile device. Furthermore, the alias of the actual device ID could be changed on a daily basis so the geo-position history of the device can only be analyzed on a daily basis.

The invention has been described as generating Internet documents or web pages. These documents are often complex web pages containing several individual files such as for graphics, text, and motion video and sound. Sometimes these files include small programs such as cgi scripts. Standard world-wide-web pages use the hyper-text-transfer protocol (http), but other protocols can be used in the URL.

Traffic counters could be a function of both traffic factors, and non-traffic factors such as ranking information used to determine document relevance. One or more traffic counters could be used to rank search results. A traffic counter could count the repeat traffic, which is a better indicator of the quality of a business.

Adjusting for business size may not be very accurate because customer capacity may not be directly proportional to the area of the business. Another way is to normalize statistics so they can be compared fairly with other businesses. For example, a counter could be normalized on a per visitor basis. The number of repeat visitors could be divided by total visitors, giving the percentage of repeat visitors at a business. A high percentage may mean most visitors are repeat customers. The total number of repeat visits could be divided by the number of repeat visitors. This gives the average number of repeat visits per repeat visitor. A high number means repeat customers go back often.

The age of the position entries could also be considered. Older entries may be given less weight or may be removed from consideration if they are more than a certain age. A plurality of traffic scores for each business can be generated to keep track of different traffic statistics. For example, traffic scores can be used to (a) track number of total visits, (b) number of total visitors, (c) number of repeat visits, (d) number of repeat visitors, (e) number of repeat visits divided by total visits, (f) number of repeat visits divided by number of repeat visitors, (g) number of repeat visits divided by number of repeat visitors in the last 12 months, (h) number of repeat visits divided by number of repeat visitors in the last 12 months with each visit weighed by visitor score, etc. Different combinations of traffic scores can be used to rank search results. For example, search results can be ranked by the percentage of repeat visits by dividing number of repeat visits by number of total visits, or by the percentage of repeat visitors by dividing number of repeat visitors by number of total visitors.

Examples of equations to measure (a) to (h) above are:
ts(L)=v, (a)

where ts(L) is the traffic score of location L, and v is the total number of visits to L;
(b) ts(L)=vt, (b)

where vt is the number of visitors who have visited L one or more times;
ts(L)=vr, (c)

where vr is the number of visits by visitors who have been to L before;

ts(L)=vtr, (d)

where vtr is the number of visitors who have visited L more than once before;
ts(L)=v/vt; (e)
ts(L)=vr/vtr; (f)
ts(L)=vrl 2/vtrl 2, (g)

where vrl 2 is the number of visits by visitor who have been to L before in the last 12 months, and vtrl 2 is the number of visitors who have visited L more than once before in the last 12 months;

and ts(L)=(vs[0 ]+vs[1]+. . . +vs[vr12])/vtrl 2, (h)

where vs[i] is the visitor score of the i^{th} visitor who have been to L before in the last 1 2 months.

The algorithm used to compute the traffic rank is very important for getting good results. Each visit or each traffic counter could be given different weights based on one or more combinations of business information, visitor information, visitor scores, user ratings, visit information, traffic scores, search terms, sort priorities, etc.

Some customers may be better judges than others, so visits by better judges could be given more weight. A recursive algorithm similar Google's Page Rank could be used, where traffic scores are based on visitor scores, and visitor scores are based on traffic scores of businesses users had visited. For example, if a visitor tends to go to eat in the most popular restaurants, then if he eats at a restaurant, then this restaurant should also be popular if he goes back. In contrast, if a visitor tends to eat an all kinds of restaurants, then his opinion is not very reliable. If a recursive algorithm is used and the traffic score of a business is updated, dependent visitor scores may need to be updated, which in turn may require dependent traffic scores of other businesses to be updated.

The rating system can be implemented across multiple providers. For example, cellular service providers generate geo-position databases. A traffic analysis service provider receives geo-position data from cellular service providers, maintains a location database and generates the traffic scores. While a local search service provider receives traffic scores from the traffic analysis provider, it maintains its own location database, and provides the search service. The term visit could be defined in ways other than entry and exit. For example, each hit could be counted as a visit, although this may lack accuracy. Or, if a visitor is determined to have been at a business for at least 10 minutes, then it could count as a visit. Note that geo-position data does not have to be analyzed in real time.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A popularity-rating system using geo-position data collected from mobile devices comprising:
a device geo-position database having geo-position data that indicate physical positions of mobile devices;
a location database having location entries that have a location identifier, a physical location corresponding to the location identifier, and a traffic score for the location identifier;
a traffic analyzer, coupled to read geo-position data from the device geo-position database, the traffic analyzer comparing geo-position data to the physical location in a matching location entry in the location database;
a count adjuster, coupled to the traffic analyzer, for updating the traffic score in the matching location entry when the traffic analyzer determines that the geo-position data for a mobile device is at the physical location for the matching location entry;
a location search engine, receiving search terms from a search client, for searching a search database of location entries using the search terms to generate a result set of location identifiers; and
a result sorter, coupled to receive the result set from the location search engine, using traffic scores from selected location entries in the location database that have location identifiers that correspond to the location identifiers in the result set, the result sorter generating a sorted list of the location identifiers in the result set;
wherein the sorted list of the location identifiers in the result set is sorted at least partially by values of the traffic scores for location identifiers in the result set,
whereby search results are sorted using traffic scores of mobile devices having geo-positions at the physical locations for location identifiers in the sorted list.

2. The popularity-rating system of claim 1 wherein the device geo-position database stores geo-position data, time, and device identifiers, the device identifiers identifying a mobile device.

3. The popularity-rating system of claim 2 further comprising:
a visit detector that compares a prior or later geo-position of a mobile device to the physical location in the matching location entry in the location database to determine when the prior or later geo-position was not in the physical location of the matching location entry
wherein the count adjuster adjusts the traffic score in the matching location entry when the traffic analyzer determines that the geo-position data for the mobile device is or was at the physical location for the matching location entry, and when the entry detector determines that the prior or later geo-position for the mobile device was not in the physical location of the matching location entry,
whereby traffic scores are adjusted when a visit is detected.

4. The popularity-rating system of claim 2 further comprising:
an entry detector that compares a prior geo-position of a mobile device to the physical location in the matching location entry in the location database to determine when the prior geo-position was not in the physical location of the matching location entry;
wherein the count adjuster adjusts the traffic score in the matching location entry when the traffic analyzer determines that the geo-position data for the mobile device is at the physical location for the matching location entry, and when the entry detector determines that the prior geo-position for the mobile device was not in the physical location of the matching location entry,
whereby traffic scores are adjusted when entry is detected.

5. The popularity-rating system of claim 3 wherein the geo-position data is obtained by triangulation from multiple transceivers, or from satellite Global-Positioning-Satellite (GPS) data.

6. The popularity-rating system of claim 5 wherein the visit detector uses an error factor to determine when geo-positions overlap with the physical location of the matching location entry.

7. The popularity-rating system of claim 6 wherein the error factor varies with a precision of the geo-position data, the precision of the geo-position data varying with a number of GPS satellites or a number of multiple transceivers used to generate the geo-position data.

8. The popularity-rating system of claim 5 wherein the location database further stores shape indicators that indicate a shape or area of the physical location of the location identifier.

9. The popularity-rating system of claim 8 wherein the shape indicators have a list of Cartesian or polar coordinates for a location identifier.

10. The popularity-rating system of claim 3 wherein the traffic counter is a repeat counter; further comprising:
a repeat-count adjuster, coupled to the traffic analyzer, for adjusting a repeat counter in the matching location entry when the traffic analyzer determines that the geo-position data for a mobile device is at the physical location for the matching location entry, and the mobile device has visited the physical location at an earlier visit;
wherein the result sorter reads the repeat counters from selected location entries in the location database that have location identifiers that correspond to the location identifiers in the result set, the result sorter generating a sorted list of the location identifiers in the result set;
wherein the sorted list of the location identifiers in the result set is at least partially sorted by values of the repeat counters for location identifiers in the result set,
whereby results are sorted using repeat counters of mobile devices re-visiting physical locations for location identifiers in the sorted list.

11. The popularity-rating system of claim 10 further comprising:
a prior-visitor list having entries listing mobile devices that have previously visited the physical location of a location identifier;
wherein the traffic analyzer reads the prior-visitor list to determine when the mobile device has visited the physical location at an earlier date to update the repeat counter.

12. The popularity-rating system of claim 10 wherein the traffic analyzer reads device geo-position database for a prior entry to determine when the mobile device has visited the physical location at an earlier date to update the repeat counter.

13. The popularity-rating system of claim 3 wherein the location search engine restricts the result set to a physical region around a search center,
whereby a local search is performed and ranked based at least partially on the traffic scores.

14. The popularity-rating system of claim 13 wherein the location search engine calculates distances from the search center to physical locations of the location identifiers, and selects location identifiers having distances less than a limit for inclusion in the result set of location identifiers;
wherein the result sorter receives the result set and the distances from the location search engine;
wherein the sorted list of the location identifiers in the result set is limited by the distances and partially sorted by values of the traffic scores for location identifiers in the result set.

15. The popularity-rating system of claim 14 wherein the location identifier is a business name, the location database being a business database that includes restaurants.

16. A computerized method for rating businesses comprising:
automatically obtaining geo-position data points indicating positions of mobile devices, each geo-position data point having a geo-position and a time and a device identifier that uniquely identifies a mobile device;
for each geo-position data point:
comparing the geo-position to business locations stored in a business database to find a matching entry, the matching entry having a business location that overlaps with the geo-position, the matching entry also having a business name and a mobile-device-traffic counter;
detecting a boundary crossing when the mobile device has crossed a boundary of the business location by detecting when the geo-position of the mobile device first overlaps the business location or no longer overlaps the business location;
updating the mobile-device-traffic counter in the matching entry when the boundary crossing is detected when the mobile device has crossed the boundary of the business location;
receiving search terms from a search user on a network;
searching a search database for entries that satisfy the search terms to generate a result set of entries;
sorting the entries in the result set using the mobile-device-traffic counters; and
displaying ranked entries from the result set to the search user,
whereby mobile-device-traffic counters assist in ranking search results.

17. The computerized method for rating businesses of claim 16 wherein the mobile-device-traffic counters have weighted values that weight visits by mobile devices;
wherein the mobile-device-traffic counters are weighted by one or more mobile-device-traffic counters for other businesses, an age of a visit, a number of previous visits to a business location by the mobile device, a user rating, or a transaction amount of a transaction by a user of the mobile device at the business location.

18. The computerized method for rating businesses of claim 17 further comprising:
generating ranking values for business locations, the mobile-device-traffic counters from entries in the business database being a factor in generating the ranking values;
sorting the entries in the result set using the ranking values that are generated in part from the mobile-device-traffic counters; and
displaying highest-ranked entries from the result set to the search user, whereby mobile-device-traffic counters assist in ranking search results.

19. The computerized method for rating businesses of claim 18 further comprising:
determining a repeat visit when the geo-position for the mobile device with a same device identifier has previously overlapped the business location on another occasion and has again crossed the boundary of the business location;
wherein the mobile-device-traffic counter is a repeat-traffic counter; the mobile-device-traffic counter in the matching entry being updated when the boundary crossing and the repeat visit are detected when the mobile device has crossed the boundary of the business location; and
generating ranking values for business locations, the repeat-traffic counters from entries in the business database being a factor in generating the ranking values,
whereby repeat-visit counters assist in ranking search results.

20. The computerized method for rating businesses of claim 16 further comprising:
transmitting a rating form to a departing mobile device generating a boundary crossing that no longer overlaps the business location;
receiving a user rating from the departing mobile device in response to the rating form; and
accumulating the user rating in a user-rating indicator for the matching entry, whereby user ratings are collected from users of departing mobile devices.

21. A computer-program product comprising:
a computer-usable medium having computer-executable program code means embodied therein for ranking businesses using mobile-device geo-position data, the computer-executable program code means in the computer-program product comprising:
geo-position read means for reading geo-position events that contain time, geo-position, and device ID data for mobile devices including mobile phones;
position compare means for comparing geo-positions from the geo-position events to business locations and locating a matching business record when a geo-position is within a business location;
counter update means for updating a traffic counter for the matching business record to account for a visit by a mobile-device-carrying customer;
weighting means for weighting values of traffic counters;
search means, receiving search requests from users, for finding result business locations in response to the search requests; and
sort means, coupled to the search means, for sorting the result business locations into a sorted order of the result business names, wherein the traffic counters for the resulting business locations are used to order the result business locations into the sorted order for display to the users,
whereby business locations are ranked using traffic counters updated by geo-position events for mobile devices.

22. The computer-program product of claim 21 further comprising:
visible traffic indicator means for visibly displaying a traffic indication to the user, the traffic indication being generated from the traffic counters for the resulting business locations.

23. The computer-program product of claim 21 further comprising:
ranking means for generating rank values for business locations using the traffic counters, wherein business locations with traffic counters that indicate more visits by mobile-device-carrying customers have a higher rank value than business locations with traffic counters that indicate fewer visits by mobile-device-carrying customers;
whereby business locations are ranked using traffic counters updated by geo-position events for mobile devices.

24. The computer-program product of claim 21 further comprising:
entry-detect means for detecting entry or exit of a mobile device having a device ID into or out from a business location by detecting crossing of a boundary of a business location by a geo-position for the mobile device having the device ID;
wherein the counter update means is activated by the entry-detect means in response to entry or exit of the mobile device at the business location.

25. The computer-program product of claim 21 further comprising:
device geo-position database means for storing the geo-position events; and business database means for storing the matching business record and other business records each having a business location and a traffic counter for the business location.
